(19) United States
(12) Patent Application Publication
(10) Pub. No.: US 2025/0150695 A1
(43) Pub. Date: May 8, 2025

(54) CAMERA MODULE

(71) Applicant: Samsung Electro-Mechanics Co., Ltd., Suwon-si (KR)

(72) Inventors: Nam Ju LEE, Suwon-si (KR); Kyung Hun LEE, Suwon-si (KR); Young Bok YOON, Suwon-si (KR); Byung Woo KANG, Suwon-si (KR); Tae Yeon LIM, Suwon-si (KR)

(73) Assignee: Samsung Electro-Mechanics Co., Ltd., Suwon-si (KR)

(21) Appl. No.: 18/896,509

(22) Filed: Sep. 25, 2024

(30) Foreign Application Priority Data
Nov. 3, 2023 (KR) 10-2023-0151177
Apr. 9, 2024 (KR) 10-2024-0047706

(51) Int. Cl. H04N 23/55; H04N 23/54; H04N 23/57

(52) U.S. Cl. CPC H04N 23/55; H04N 23/54; H04N 23/57

(57) ABSTRACT

A camera module includes a first lens group including a lens disposed in a direction of a first optical axis, a second lens group including a lens disposed in a direction of a second optical axis, intersecting the first optical axis, a first optical path conversion unit configured to reflect light incident through the first lens group to the second lens group, an image sensor having a third optical axis which intersects the second optical axis, a second optical path conversion unit configured to reflect the light incident through the second lens group to the image sensor, and a first driving unit configured to drive at least one of the first optical path conversion unit, the second optical path conversion unit, and the image sensor. In the camera module, the first optical axis and the third optical axis are configured to form an acute angle.

### CROSS-REFERENCE TO RELATED APPLICATIONS

This application claims the benefit under 35 USC § 119 (a) of Korean Patent Application No. 10-2024-0047706 filed on Apr. 9, 2024, and Korean Patent Application No. 10-2023-0151177 filed on Nov. 3, 2023, in the Korean Intellectual Property Office, the entire disclosures of which are incorporated herein by reference for all purposes.

### BACKGROUND

### 1. Field

The following description relates to a camera module.

### 2. Description of Related Art

Portable electronic devices include camera modules. For example, portable devices, such as, but not limited to, portable phones, laptops, and the like, may typically include one or more camera modules. As photography and video recording using portable electronic devices become more common, there is a demand for improved camera module performance. However, since small portable terminals generally have a relatively thin thickness, it may be difficult to install a camera module having high performance and high resolution. For example, in order to reduce or miniaturize a telephoto camera module having a long focal length, an image sensor package should also be small. However, for high-resolution imaging and filming, an image sensor or an image sensor package of a sufficient size is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a first lens group comprising a lens disposed in a direction of a first optical axis; a second lens group comprising a lens disposed in a direction of a second optical axis, intersecting the first optical axis; a first optical path conversion unit configured to reflect light incident through the first lens group to the second lens group; an image sensor configured to convert light incident through the second lens group into an electrical signal, and having a third optical axis which intersects the second optical axis; a second optical path conversion unit disposed between the second lens group and the image sensor and configured to reflect the light incident through the second lens group to the image sensor; and a first driving unit configured to drive at least one of the first optical path conversion unit and the image sensor, wherein the first optical axis and the third optical axis are configured to form an acute angle.

The first driving unit may be configured to move the first optical path conversion unit in a first direction intersecting the first optical axis.

The first driving unit may be configured to move the first optical path conversion unit in a first direction intersecting the first optical axis and a second direction intersecting the first optical axis.

The first driving unit may be configured to move the image sensor in a third direction intersecting the third optical axis.

The first driving unit may be configured to move the image sensor in a third direction intersecting the third optical axis and a fourth direction intersecting the third optical axis.

The camera module may further include a second driving unit configured to move the second lens group in the direction of the second optical axis.

The first optical path conversion unit may be configured to have positive refractive power.

An emission surface of the first optical path conversion unit may have a convex shape.

In a general aspect, a camera module includes a first lens group, a first optical path conversion unit, a second lens group, a second optical path conversion unit, and an image sensor arranged sequentially along an optical axis direction, and a first driving unit configured to drive the first optical path conversion unit in a direction intersecting an optical axis, wherein the image sensor is disposed to form an acute angle with an entrance surface of the second optical path conversion unit.

The camera module may further include a second driving unit configured to drive the second lens group in the optical axis direction.

The camera module may further include a ball bearing disposed between the second lens group and a housing that accommodates the second lens group.

The first lens group may have positive refractive power.

An emission surface of the first optical path conversion unit may have a convex shape.

The first driving unit may be configured to drive the first optical path conversion unit in a first direction intersecting the optical axis and a second direction intersecting the optical axis.

The second optical path conversion unit may be configured to include two or more reflective surfaces.

In a general aspect, a camera module includes a first lens group comprising at least one lens disposed in a direction of a first optical axis; a second lens group disposed in a direction of a second optical axis, intersecting the first optical axis; an image sensor; a first optical path conversion unit configured to reflect light incident through the first lens group to the second lens group; a second optical path conversion unit disposed between the second lens group and the image sensor and configured to reflect light incident through the second lens group to the image sensor; and a driving unit configured to move the first optical path conversion unit in a direction intersecting the first optical axis, and configured to rotate the first optical path conversion unit based on the first optical axis.

A second lens of the second lens group may have positive refractive power, and a third lens of the second lens group may have negative refractive power.

Other features and aspects will be apparent from the following detailed description, the drawings, and the claims.

### BRIEF DESCRIPTION OF DRAWINGS

FIG. 1 illustrates a configuration diagram of an example camera module, in accordance with a first embodiments.

FIG. 2A to FIG. 2C illustrate another form of an example first optical path conversion unit illustrated in FIG. 1.

FIG. 3 illustrates a detailed structure of an example second optical path conversion unit illustrated in FIG. 1.

FIG. 4A to FIG. 4D are configuration diagrams according to illustrative forms of an example first optical path conversion unit and an example first driving unit.

FIG. 5 is a configuration diagram according to a modified example of the camera module illustrated in FIG. 1.

FIG. 6 is a configuration diagram according to an example second lens group and a second driving unit.

FIG. 7 illustrates a configuration diagram of an example camera module in accordance with a second embodiment;

FIG. 8A and FIG. 8B are configuration diagrams of an example image sensor package and a first driving unit.

FIG. 9 illustrates a configuration diagram according to a modified example of the camera module illustrated in FIG. 7.

FIG. 10 is a configuration diagram according to an illustrative form of a second driving unit illustrated in FIG. 9.

FIG. 11 illustrates a configuration diagram of an example camera module in accordance with a third embodiment.

FIG. 12A to FIG. 12D are configuration diagrams according to illustrative forms of a first optical path conversion unit and a first driving unit.

FIG. 13A and FIG. 13B are configuration diagrams of an example image sensor package and a first driving unit.

FIG. 14 illustrates a configuration diagram according to a modified example of the camera module illustrated in FIG. 11.

FIG. 15 illustrates a configuration diagram according to an illustrative form of a second driving unit illustrated in FIG. 14.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more embodiments may provide a camera module that is configured to be mounted on a small or thin electronic device.

One or more embodiments may provide a camera module that enables high-resolution imaging and shooting (or image capture) while being mounted on a thin portable terminal.

The camera module, in accordance with one or more embodiments, may be mounted on an electronic device. In an example, the camera module may be mounted on a portable terminal, laptop, virtual reality (VR) device, glasses, or the like. However, electronic devices on which a camera module may be mounted are not limited to the devices described above. As an example, the camera module may be mounted on any portable electronic device, such as a portable game console.

A camera module according to a first aspect, may include a first lens group, a second lens group, a first optical path conversion unit, a second optical path conversion unit, an image sensor, and a first driving unit. In the camera module according to the first aspect, the first lens group may include one or more lenses. For example, the first lens group may include one or more lenses disposed along the first optical axis. In the camera module according to the first aspect, the second lens group may include one or more lenses. For example, the second lens group may include one or more lenses disposed along the second optical axis. In this example, the second optical axis may be in a direction that intersects the first optical axis. In the camera module according to the first aspect, the first optical path conversion unit may be configured to reflect light incident through the first lens group to the second lens group. In the camera module according to the first aspect, the second optical path conversion unit may be configured to reflect light incident through the second lens group to the image sensor. For example, the second optical path conversion unit may reflect light incident along the second optical axis of the second lens group toward the third optical axis of the image sensor. In this example, the third optical axis may be configured to form an acute angle with the first optical axis. In the camera module according to the first aspect, the first driving unit may drive one or more of the first optical path conversion unit and the image sensor.

The camera module according to the second aspect may include a first lens group, a second lens group, a first optical path conversion unit, a second optical path conversion unit, an image sensor, and a first driving unit. In the camera module according to the second aspect, the first lens group, the first optical path conversion unit, the second lens group, the second optical path conversion unit, and the image sensor may be sequentially arranged along the optical axis. Additionally, in the camera module according to the second aspect, the image sensor may be disposed to form an acute angle with respect to the incident surface of the second optical path conversion unit.

Below, various embodiments will be described with reference to the drawings.

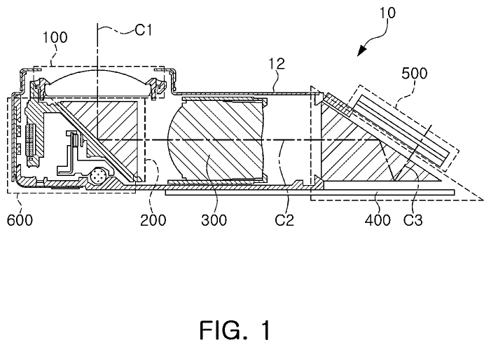

First, an example camera module according to a first embodiment will be described with reference to FIGS. 1 to 4D.

A camera module 10 according to the first embodiment may include a first lens group 100, a first optical path conversion unit 200, a second lens group 300, a second optical path conversion unit 400, and an image sensor package 500. However, the configuration of the camera module 10 according to the first embodiment is not limited to the elements described above. As an example, the camera module 10 may further include a first driving unit 600 that drives the first optical path conversion unit 200.

The first lens group 100, the first optical path conversion unit 200, the second lens group 300, the second optical path conversion unit 400, and the image sensor package 500 may be sequentially arranged along the optical axis. In an example, the first optical path conversion unit 200 may be disposed on the image side of the first lens group 100, the second lens group 300 may be disposed on the image side of the first optical path conversion unit 200, the second optical path conversion unit 400 may be disposed on the image side of the second lens group 300, and the image sensor package 500 may be disposed on the image side of the second optical path conversion unit 400.

The first lens group 100 may include one or more lenses sequentially arranged along the first optical axis C1. For example, the first lens group 100 may include a first lens having refractive power. However, the number of lenses constituting the first lens group 100 is not limited to one lens. The first lens group 100 or the first lens may have a predetermined refractive power. For example, the first lens group 100 or the first lens may have positive refractive power. The first lens group 100 or the first lens may have an overall meniscus shape. For example, the object-side surface of the first lens disposed at the forefront in the first lens group 100 may be convex, and the image-side surface of the lens disposed rearmost in the first lens group 100 may be concave. The first lens group 100 may include lenses of a predetermined size. For example, a maximum diameter of the first lens disposed at the forefront of the first lens group 100 may be larger than a maximum length (horizontal or vertical length of the incident surface) of the first optical path conversion unit 200.

The first optical path conversion unit 200 may be configured to reflect light incident along the first optical axis C1 of the first lens group 100 in the direction of the second optical axis C2 of the second lens group 300. For example, the first optical path conversion unit 200 may be configured in the form of a prism that totally reflects light incident along the first optical axis C1 in the direction of the second optical axis C2. However, the form of the first optical path conversion unit 200 is not limited to a prism. For example, it may be possible to change the first optical path conversion unit 200 into a reflector.

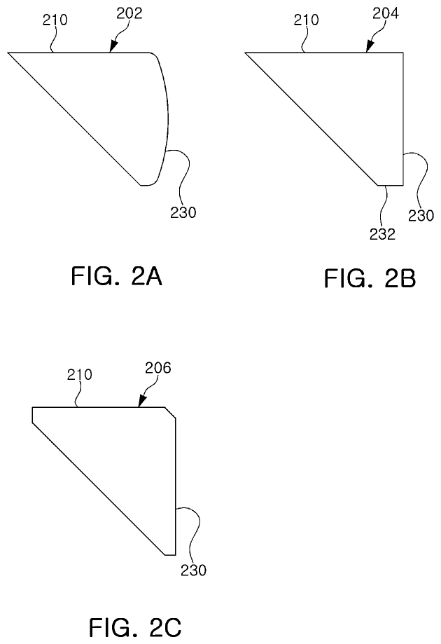

The first optical path conversion unit 200 may be configured to have a unique shape as illustrated in FIG. 2.

As an example, the first optical path conversion unit 200 may be configured to have positive refractive power. As a detailed example, the first optical path conversion unit 202 according to a first modification may have an emission surface 230 of a convex shape as illustrated in FIG. 2A. The convex shape of the emission surface 230 may be formed by integrally bonding a general prism and a plano convex lens, or by integrally molding a prism and a plano-convex lens. As another example, the first optical path conversion unit 200 may be configured so that an entrance surface 210 and the emission or exit surface 230 may be configured to have different areas.

As a detailed example, in the second optical path conversion unit 204 according to a second modification, as illustrated in FIG. 2B, the emission surface 230 may be formed to extend lengthwise along the direction of the second optical axis C2, so that the entrance surface 210 has a larger area than the emission surface 230. As another example, the first optical path conversion unit 206 may be formed in a manner where the edges or corners of the emission surface 230 are chamfered, as illustrated in FIG. 2C.

The second lens group 300 may include one or more lenses sequentially arranged along the second optical axis C2. As an example, the second lens group 300 may include a second lens and a third lens sequentially arranged along the second optical axis C1. The second lens and the third lens may respectively have positive or negative refractive power. As a detailed example, the second lens may have positive refractive power and the third lens may have negative refractive power. However, the number of lenses and the refractive power of the lenses constituting the second lens group 300 are not limited to the above-described form. For example, the second lens group 300 may be comprised of three or more lenses.

The second optical path conversion unit 400 may be configured to reflect light incident along the second optical axis C2 to the image sensor of the image sensor package 500. For example, the second optical path conversion unit 400 may include two or more reflective surfaces so that light incident along the second optical axis C2 may be incident along the third optical axis C3 of the image sensor.

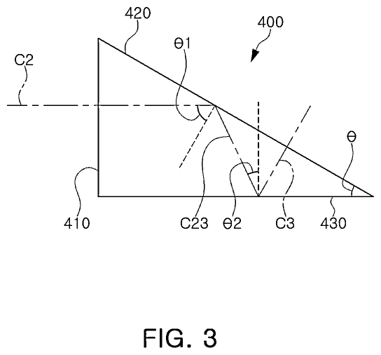

The second optical path conversion unit 400 according to an aspect will be described in detail with reference to FIG. 3.

The second optical path conversion unit 400 may include an incident surface 410, a first reflective surface 420, and a second reflective surface 430. The second optical path conversion unit 400 may have a reflective surface and an emission surface that are integrally formed. For example, the first reflective surface 420 of the second optical path conversion unit 400 may be a reflective surface on which light is reflected and an emission surface on which light is emitted.

The second optical path conversion unit 400 may be configured to obtain both total reflection and specular reflection of light. As an example, the first reflective surface 420 of the second optical path conversion unit 400 may be configured to provide total reflection of light, and the second reflective surface 430 of the second optical path conversion unit 400 may be configured to provide specular reflect light. As a detailed example, the first incident angle θ1 of the first reflective surface 420 is greater than the critical angle of the first reflective surface 420, and the second incident angle θ2 of the second reflective surface 430 may be less than the critical angle of the second reflective surface 430. The first reflective surface 420 and the second reflective surface 430 may be disposed in a predetermined shape. For example, the included angle θ between the first reflective surface 420 and the second reflective surface 430 may be 16 to 32 degrees. As a detailed example, the included angle between the first reflective surface 420 and the second reflective surface 430 may be 30 degrees or 18 degrees.

The second optical path conversion unit 400 may be configured to provide a plurality of internal reflections. To elaborate, the second optical path conversion unit 400 may be configured to perform an even number of internal reflections. For example, the second optical path conversion unit 400 may be configured to perform two or four internal reflections. The number (N) of internal reflections of the second optical path conversion unit 400 and the included angle θ between the first and second reflective surfaces 420 and 430 may satisfy the following conditional expression.

$$θ = 90 / ( 2 n + 1 ) , 2 n = N$$

In the above conditional expression, n is a positive integer. For example, when the number of internal reflections of the second optical path conversion unit 400 is 2, the included angle θ is 30 degrees. As another example, when the number of internal reflections of the second optical path conversion unit 400 is 4, the included angle θ is 18 degrees. The number of internal reflections of the second optical path conversion unit 400 may be 6 or more. However, it may be preferable that the number of internal reflections of the second optical path conversion unit 400 does not exceed 4. To explain further, in the example in which the number of internal reflections of the second optical path conversion unit 400 increases to 6 or more, the included angle θ decreases to 12.9 degrees or less and the amount of light incident on the second prism also decreases. Thus, a problem may occur in which the resolution of the camera module rapidly deteriorates. Therefore, it may be preferable that the number of internal reflections of the second optical path conversion unit 400 is 2 or 4.

The image sensor package 500 may be configured to include an image sensor (not illustrated). For example, an image sensor may be disposed on one side of the image sensor package 500 to convert light incident through the second optical path conversion unit 400 into an electrical signal. The image sensor package 500 may be disposed to face one side of the second optical path conversion unit 400. As an example, the image sensor package 500 may be disposed to face the first reflective surface 420 of the second optical path conversion unit 400.

The first driving unit 600 may be configured to enable optical image stabilization (OIS) of the camera module 10. In the present embodiment, the first driving unit 600 may be configured to move the first optical path conversion unit 200 in a direction intersecting the first optical axis C1. As an example, the first driving unit 600 may be configured to move the first optical path conversion unit 200 in the first and second directions that intersect the first optical axis C1. As another example, the first driving unit 600 may be configured to move the first optical path conversion unit 200 in a first direction intersecting the first optical axis C1 and rotate the first optical path conversion unit 200 based on the first optical axis C1.

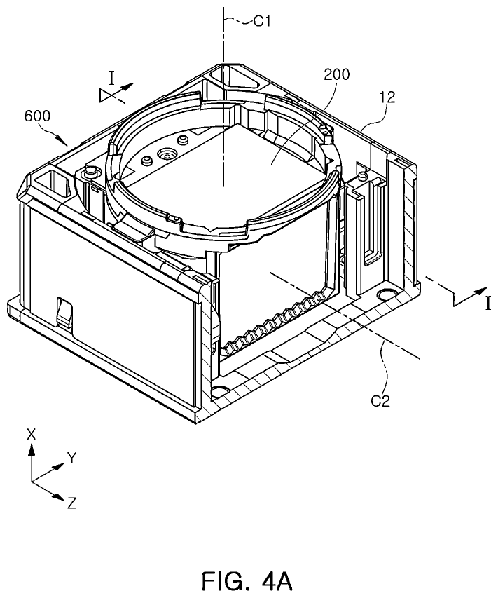

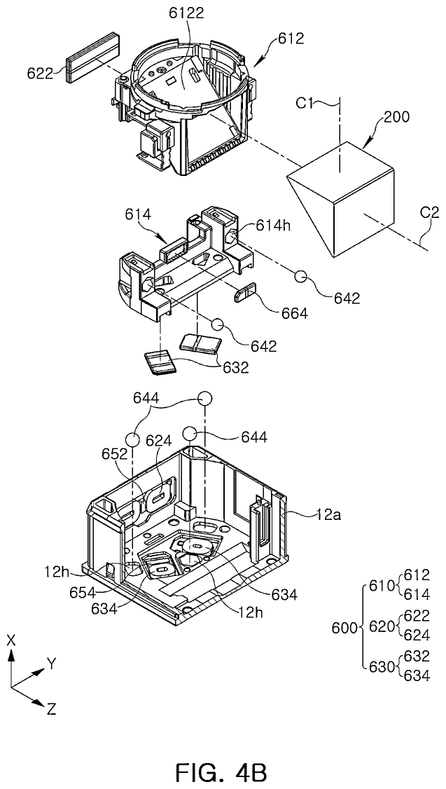

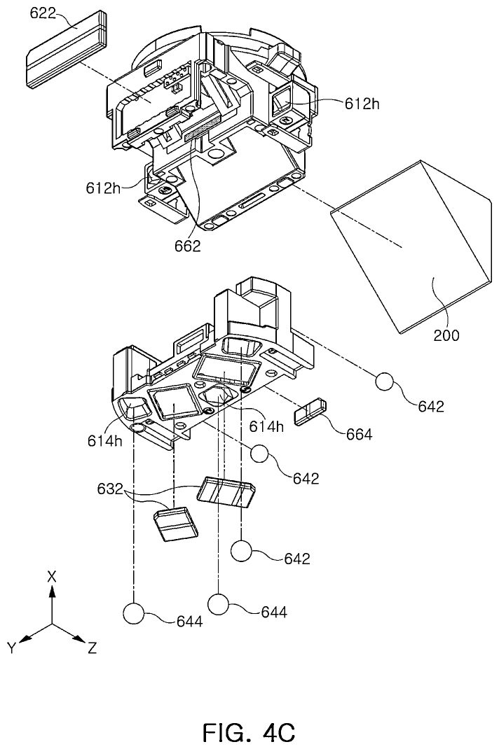

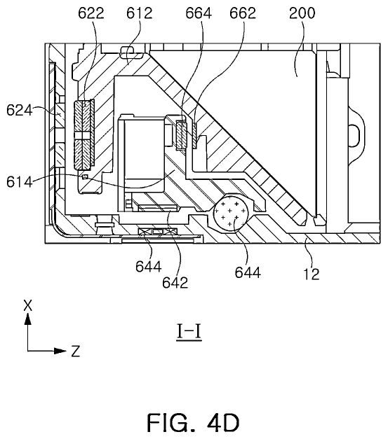

The combined structure of the first optical path conversion unit 200 and the first driving unit 600 will be described in detail with reference to FIGS. 4A to 4D.

The first driving unit 600 may be configured to partially contact or be coupled with the first optical path conversion unit 200, as illustrated in FIG. 4A. For example, the first driving unit 600 may be configured to support at least one of the reflective surface and the side surface of the first optical path conversion unit 200.

The first driving unit 600 may include a movable body 610, a first driving unit 620, and a second driving unit 630, as illustrated in FIGS. 4B and 4C. However, the configuration of the first driving unit 600 is not limited to the members described above. For example, the first driving unit 600 may further include ball bearings 642 and 644 to enable smooth movement of the first optical path conversion unit 200 or the movable body 610. As another example, the first driving unit 600 may further include Hall sensors 652 and 654 for detecting the position of the movable body 610.

The movable body 610 may be comprised of a plurality of members or elements. As an example, the movable body 610 may be comprised of a first movable body 612 and a second movable body 614. However, the configuration of the movable body 610 is not limited to the first movable body 612 and the second movable body 614. For example, the movable body 610 may be comprised of three or four members as needed. The first movable body 612 may be configured to support the first optical path conversion unit 200. As an example, a receiving portion 6122 on which the first optical path conversion unit 200 may be seated may be formed in the first movable body 612. The second movable body 614 may be configured to support the first movable body 612. The second movable body 614 may be disposed in the housing 12 of the camera module 10. For example, the second movable body 614 may be disposed on the inner bottom of the housing 12. The first movable body 612 and the second movable body 614 may be configured to rotate or move, respectively. As an example, the first movable body 612 is configured to rotate or move in one direction while being coupled to the second movable body 614, and the second movable body 614 may be configured to rotate or move in a different direction while disposed in the housing 12.

The first driving unit 620 may be configured to drive the first movable body 612. For example, the first driving unit 620 may rotate the first movable body 612 in a direction intersecting the first optical axis C1 and the second optical axis C2. The first driving unit 620 may include a first driving magnet 622 and a first driving coil 624. However, the configuration of the first driving unit 620 is not limited to the members described above. The first driving magnet 622 may be formed in the first movable body 612. For example, the first driving magnet 622 may be formed on the rear surface of the first movable body 612 facing one surface of the housing 12. The first driving coil 624 may be formed in the housing 12. For example, the first driving coil 624 may be formed on the inner side surface of the housing 12 facing the first driving magnet 622. The first driving magnet 622 and the first driving coil 624 disposed in this manner may rotate or drive the first movable body 612 in one direction based on the magnetic force generated therebetween. In an example, the first driving coil 624 may include a plurality of coils.

The second driving unit 630 may be configured to drive the second movable body 614. For example, the second driving unit 630 may rotate the second movable body 614 about the first optical axis C1. The second driving unit 630 may include a second driving magnet 632 and a second driving coil 634. However, the configuration of the second driving unit 630 is not limited to the members described above. The second driving magnet 632 may be formed in the second movable body 614. For example, the second driving magnet 632 may be formed on a lower surface of the second movable body 614 facing the bottom of the housing 12. The second driving coil 634 may be formed in the housing 12. For example, the second driving coil 634 may be formed on the bottom of the housing 12 facing the second driving magnet 632. The second driving magnet 632 and the second driving coil 634 disposed in this manner may rotate or drive the second movable body 614 in one direction through the magnetic force generated therebetween.

The ball bearings 642 and 644 may be configured to enable smooth operation of the first movable body 612 and the second movable body 614. As an example, the first ball bearing 642 may be disposed between the first movable body 612 and the second movable body 614, and the second ball bearing 644 may be disposed between the second movable body 614 and the housing 12. For reference, grooves 612h, 614h, and 12h for receiving the ball bearings 642 and 644 may be formed in the first movable body 612, the second movable body 614, and the housing 12, respectively. On the other hand, in an example, at least some of the grooves 612h, 614h, and 12h may have a polygonal cross-sectional shape rather than a circular shape, to significantly reduce the contact area with the ball bearings 642 and 644.

Hall sensors 652 and 654 may be configured to detect the positions of the first movable body 612 and the second movable body 614. For example, the first Hall sensor 652 may be disposed between respective coils of the first driving coil 624, or adjacent to the first driving coil 624, and is configured to detect the movement of the first movable body 612, and the second Hall sensor 654 may be disposed on one side of the second driving coil 634 and is configured to detect the movement of the second movable body 614. However, the arrangement of the Hall sensors 652 and 654 is not limited to the above-mentioned positions.

The first driving unit 600 may further include a component that prevents the first movable body 612 from being separated. For example, the first driving unit 600 may include a pair of magnetic bodies 662 and 664 configured to generate an attractive force between the first movable body 612 and the second movable body 614. The first magnetic body 662 may be disposed on one side of the first movable body 612 (see FIGS. 4C and 4D), and the second magnetic body 664 may be disposed on one side of the second movable body 614 (see FIGS. 4B and 4D). The magnetic bodies 662 and 664 configured in this manner may suppress the separation of the first movable body 612 from the second movable body 614 through mutual attraction thereof.

In the camera module 10 configured as above, a straight optical path may be concentrated in a limited space through the first optical path conversion unit 200 and the second optical path conversion unit 300. Additionally, since the camera module 10 according to the present embodiment may perform optical image stabilization based on the first driving unit 600, high-resolution implementation may be possible. Additionally, in the camera module 10 according to the present embodiment, the image sensor package 500 may be widely disposed along the diagonal direction of the first optical path conversion unit 300, and thus, it may be easy to mount large image sensors and electronic components necessary for high-resolution implementation.

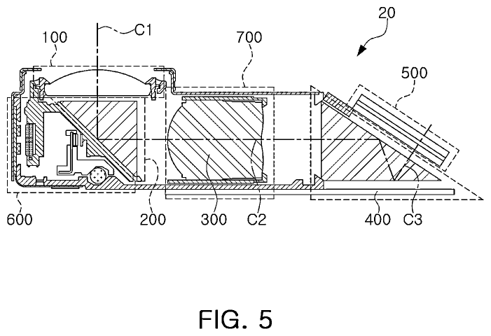

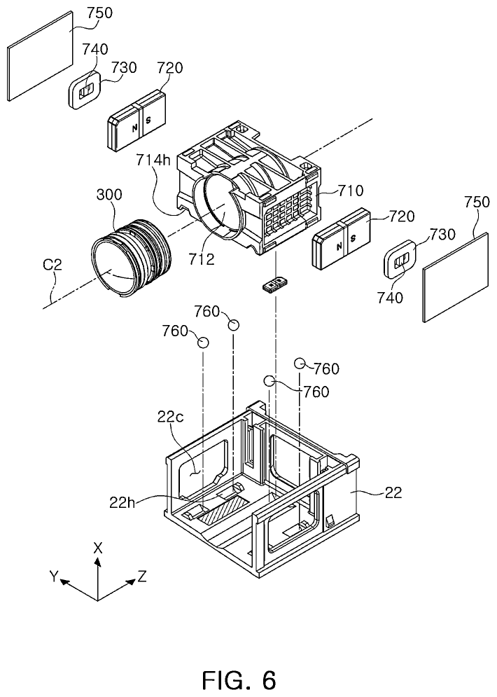

Next, another form of the example camera module according to the first embodiment will be described with reference to FIGS. 5 and 6. For reference, in an example camera module 20 according to this form, components that are the same as those in the above-described embodiment use substantially the same symbols as those in the above-described embodiment, and detailed descriptions of these components are omitted.

The camera module 20 according to this form may be distinguished from the camera module 10 according to the above-described embodiment in that it further includes a second driving unit 700. To elaborate, the camera module 20 according to this embodiment may further include the second driving unit 700 that drives the second lens group 300 in the direction of the second optical axis C2.

The configuration of the second driving unit 700 will be described with reference to FIG. 6.

The second driving unit 700 may include a movable body 710, a driving magnet 720, a driving coil 730, a detection sensor 740, and a circuit board 750. However, the configuration of the second driving unit 700 is not limited to the members described above. For example, the second driving unit 700 may further include a ball bearing 760.

The movable body 710 may be disposed inside a housing 22. For example, the movable body 710 may be disposed while maintaining a predetermined distance from the bottom of the housing 22 or may be disposed to partially contact the bottom of the housing 22. The movable body 710 may be configured to accommodate the second lens group 300. For example, a receiving portion 712 may be formed in the movable body 710 to accommodate the second lens group 300. The movable body 710 may be configured to move in the direction of the second optical axis C2. To explain further, the movable body 710 may be moved along the second optical axis C2 while combined with the second lens group 300. For reference, a ball bearing 760 may be disposed between the movable body 710 and the housing 22 to allow the movable body 710 to move smoothly. To be more specific, the ball bearing 760 may be disposed between the groove 22h of the housing 22 and the groove 714h of the movable body 710.

The driving magnet 720 and the driving coil 730 may be formed in the movable body 710 and the housing 22, respectively. For example, the driving magnet 720 may be formed on both sides of the movable body 710, and the driving coil 730 may be disposed in the through hole 22c of the housing 22, using the substrate 750 as a medium. The driving magnet 720 and the driving coil 730 may be disposed to face each other. The driving magnet 720 and driving coil 730 configured in this manner may move the second lens group 300 and the movable body 710. For example, the driving magnet 720 and the driving coil 730 may move the second lens group 300 and the movable body 710 in the direction of the second optical axis C2. For reference, the driving magnet 720 may be preferably formed long in the direction of the second optical axis C2 so that it may interact with the driving coil 730 even at a changed position of the movable body 710.

The camera module 20 configured as above includes all the features of the camera module 10 described above and has the feature of being able to adjust the focal length of the camera module through the second driving unit 700.

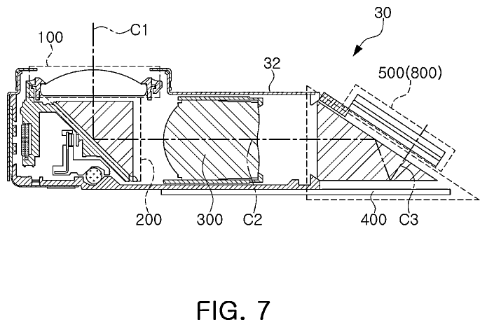

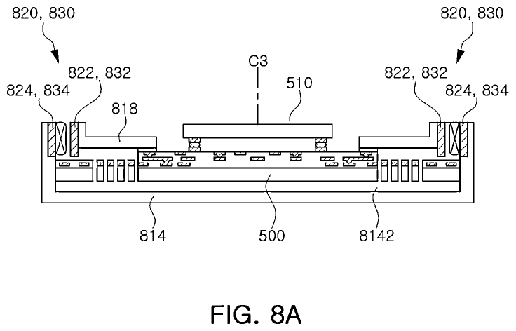

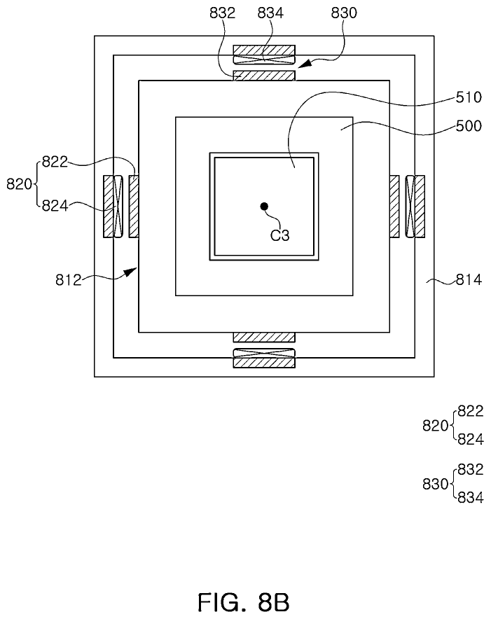

An example camera module according to a second embodiment will be described with reference to FIGS. 7 and 8.

An example camera module 30 according to a second embodiment may include a first lens group 100, a first optical path conversion unit 200, a second lens group 300, a second optical path conversion unit 400, and an image sensor package 500. However, the configuration of the example camera module 30 according to the second embodiment is not limited to the members described above. As an example, the camera module 30 may further include a first driving unit 800 which drives the second optical path conversion unit 400.

The first lens group 100, the first optical path conversion unit 200, the second lens group 300, the second optical path conversion unit 400, and the image sensor package 500 may be sequentially arranged along the optical axis. For example, the first optical path conversion unit 200 may be disposed on the image side of the first lens group 100, the second lens group 300 may be disposed on the image side of the first optical path conversion unit 200, the second optical path conversion unit 400 may be disposed on the image side of the second lens group 300, and the image sensor package 500 may be disposed on the image side of the second optical path conversion unit 400.

The first lens group 100 may include one or more lenses sequentially arranged along the first optical axis C1. For example, the first lens group 100 may include a first lens having refractive power. However, the number of lenses constituting the first lens group 100 is not limited to one lens. The first lens group 100 or the first lens may have a predetermined refractive power. For example, the first lens group 100 or the first lens may have positive refractive power. The first lens group 100 or the first lens may have an overall meniscus shape. For example, the object-side surface of the first lens disposed at the front in the first lens group 100 may be convex, and the image-side surface of the lens disposed rearmost in the first lens group 100 may be concave. The first lens group 100 may include lenses of a predetermined size. For example, the maximum diameter of the first lens disposed at the forefront of the first lens group 100 may be larger than the maximum length (horizontal or vertical length of the incident surface) of the first optical path conversion unit 200.

The first optical path conversion unit 200 may be configured to reflect light incident along the first optical axis C1 of the first lens group 100 in the direction of the second optical axis C2 of the second lens group 300. For example, the first optical path conversion unit 200 may be configured in the form of a prism that totally reflects light incident along the first optical axis C1 in the direction of the second optical axis C2. However, the form of the first optical path conversion unit 200 is not limited to a prism. For example, it may be possible to change the first optical path conversion unit 200 into a reflector.

The first optical path conversion unit 200 may be configured in the same or similar form as the first optical path conversion unit according to the first embodiment. For example, the first optical path conversion unit 200 may be changed to the shape illustrated in FIGS. 2A to 2C other than the shape illustrated in FIG. 7.

The second lens group 300 may include one or more lenses sequentially arranged along the second optical axis C2. As an example, the second lens group 300 may include a second lens and a third lens sequentially arranged along the second optical axis C1. The second lens and the third lens may respectively have positive or negative refractive power. As a detailed example, the second lens may have positive refractive power and the third lens may have negative refractive power. However, the number and refractive power of the lenses constituting the second lens group 300 are not limited to the above-described form. In an example, the second lens group 300 may be comprised of three or more lenses.

The second optical path conversion unit 400 may be configured to reflect light incident along the second optical axis C2 to the image sensor of the image sensor package 500. For example, the second optical path conversion unit 400 may include two or more reflective surfaces so that light incident along the second optical axis C2 may be incident along the third optical axis C3 of the image sensor. For example, the second optical path conversion unit 400 according to the second embodiment may have substantially the same or a similar form and characteristics as the second optical path conversion unit according to the first embodiment illustrated in FIG. 3.

The image sensor package 500 may be configured to include an image sensor (not illustrated). In an example, an image sensor may be disposed on one surface of the image sensor package 500 to convert light incident through the second optical path conversion unit 400 into an electrical signal. The image sensor package 500 may be disposed to face one surface of the second optical path conversion unit 400. As an example, the image sensor package 500 may be disposed to face the first reflective surface of the second optical path conversion unit 400.

The first driving unit 800 may be configured to enable optical image stabilization (OIS) of the camera module 30. In the present embodiment, the first driving unit 800 may be configured to move the image sensor package 500 or the image sensor 510 (see FIG. 8A) in a direction intersecting the third optical axis C3.

The combined structure of the image sensor package 500 and the first driving unit 800 will be described with reference to FIGS. 8A and 8B.

The first driving unit 800 may be formed in the image sensor package 500. As an example, the first driving unit 800 may be formed in a partial area of the image sensor package 500 or may be formed integrally with the image sensor package 500. As another example, the first driving unit 800 may be configured to accommodate the image sensor package 500. The first driving unit 800 may include a movable body 812, a fixed body 814, a first driving unit 820, and a second driving unit 830. However, the configuration of the first driving unit 800 is not limited to the above-described members.

The movable body 812 may be configured to be combined with the image sensor package 500 or the image sensor 510. For example, the movable body 812 may be coupled to the image sensor package 500 or may be configured to accommodate the image sensor 510. The movable body 812 may be configured to be electrically connected to the image sensor package 500 or the image sensor 510. In an example, the movable body 812 may be configured in the form of a printed circuit board. However, the shape of the movable body 812 is not limited to a printed circuit board. The fixed body 814 may be configured to accommodate the movable body 812. For example, a receiving portion 8142 may be formed inside the fixed body 814 to accommodate the movable body 812 and the image sensor package 500. Like the movable body 812, the fixed body 814 may be configured to be electrically connected to the image sensor package 500 or the image sensor 510. In an example, the fixed body 814 may be configured in the form of a printed circuit board. However, the shape of the fixed body 814 is not limited to a printed circuit board.

The first driving unit 820 may include a first driving magnet 822 and a first driving coil 824. However, the configuration of the first driving unit 820 is not limited to the members described above. The first driving magnet 822 and the first driving coil 824 may be disposed to face each other or to be adjacent to each other. In an example, the first driving magnet 822 may be formed in the movable body 812, and the first driving coil 824 may be formed in the fixed body 814. In another example, the first driving magnet 822 may be formed on the fixed body 814, and the first driving coil 824 may be formed on the movable body 812. The first driving unit 820 configured in this manner may move the image sensor 510 or the image sensor package 500 in the first direction that intersects the third optical axis C3, based on the magnetic force generated between the first driving magnet 822 and the first driving coil 824.

The second driving unit 830 may include a second driving magnet 832 and a second driving coil 834. However, the configuration of the second driving unit 830 is not limited to the members described above. The second driving magnet 832 and the second driving coil 834 may be disposed to face each other, or may be adjacent to each other. For example, the second driving magnet 832 may be formed in the movable body 812, and the second driving coil 834 may be formed in the fixed body 814. As another example, the second driving magnet 832 may be formed on the fixed body 814, and the second driving coil 834 may be formed on the movable body 812. The second driving unit 830 configured in this manner may move the image sensor 510 or the image sensor package 500 in the second direction intersecting the third optical axis C3, based on the magnetic force generated between the second driving magnet 832 and the second driving coil 834.

For reference, the driving units 820 and 830 according to the present embodiment are comprised of a driving magnet and a driving coil, but it may also be possible to change the configuration of the driving units 820 and 830 in the range of moving the movable body 812 in a direction intersecting the third optical axis C3. For example, in a modified form of the embodiment, it may be possible to change the driving units 820 and 830 to a shape memory alloy, a piezoelectric member, or the like.

The camera module 30 configured as above may implement a telephoto imaging optical system with a long focal length. Additionally, the camera module 30 according to the present embodiment may directly or indirectly adjust the position of the image sensor 510 where the image is formed through the first driving unit 800, thereby performing more accurate and rapid optical image stabilization. Additionally, in the camera module 30 according to the present embodiment, the image sensor package 500 may be widely disposed along the diagonal direction of the first optical path conversion unit 300, and thus, it may be easy to mount large image sensors and electronic components necessary for high-resolution implementation.

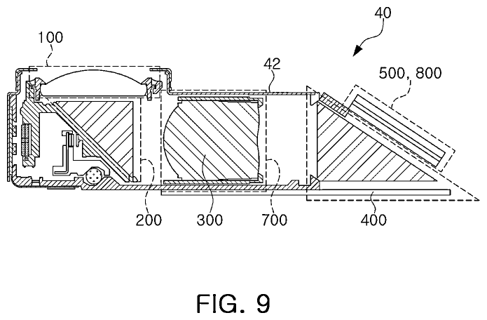

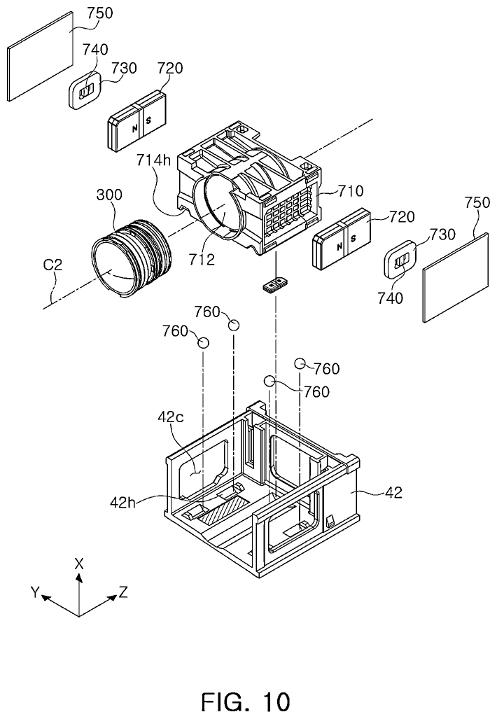

Next, a modified form of the camera module according to the second embodiment will be described with reference to FIGS. 9 and 10. For reference, in a camera module 40 according to this form, components that are the same as those in the above-described embodiment use substantially the same symbols as those in the above-described embodiment, and detailed descriptions of these components will be omitted.

The camera module 40 according to this form may be distinguished from the camera module 30 according to the above-described embodiment in that it further includes a second driving unit 700. To elaborate, the camera module 20 according to this form may further include a second driving unit 700 that drives the second lens group 300 in the direction of the second optical axis C2.

The configuration of the second driving unit 700 will be described with reference to FIG. 10.

The second driving unit 700 may include a movable body 710, a driving magnet 720, a driving coil 730, a detection sensor 740, and a circuit board 750. However, the configuration of the second driving unit 700 is not limited to the members described above. For example, the second driving unit 700 may further include a ball bearing 760.

The movable body 710 may be disposed inside the housing 42. For example, the movable body 710 may be disposed while maintaining a predetermined distance from the bottom of the housing 42 or may be disposed to partially contact the bottom of the housing 42. The movable body 710 may be configured to accommodate the second lens group 300. For example, a receiving portion 712 may be formed in the movable body 710 to accommodate the second lens group 300. The movable body 710 may be configured to move in the direction of the second optical axis C2. Specifically, the movable body 710 may be moved along the second optical axis C2 while being combined with the second lens group 300. In an example, the ball bearing 760 may be disposed between the movable body 710 and the housing 42 to allow the movable body 710 to move smoothly. To be more specific, the ball bearing 760 may be disposed between the groove 42h of the housing 42 and the groove 714h of the movable body 710.

The driving magnet 720 and the driving coil 730 may be formed in the movable body 710 and the housing 42, respectively. For example, the driving magnet 720 may be formed on both sides of the movable body 710, and the driving coil 730 may be disposed in the through hole 42c of the housing 42, using the substrate 750 as a medium. The driving magnet 720 and the driving coil 730 may be disposed to face each other. The driving magnet 720 and driving coil 730 configured in this manner may move the second lens group 300 and the movable body 710. For example, the driving magnet 720 and the driving coil 730 may move the second lens group 300 and the movable body 710 in the direction of the second optical axis C2. In an example, the driving magnet 720 may be preferably formed lengthwise in the direction of the second optical axis C2 so that it may interact with the driving coil 730 even in a changed position of the movable body 710.

The camera module 40 configured as above includes all the features of the camera module 30 described above and has the feature of being able to adjust the focal length of the camera module based on an operation of the second driving unit 700.

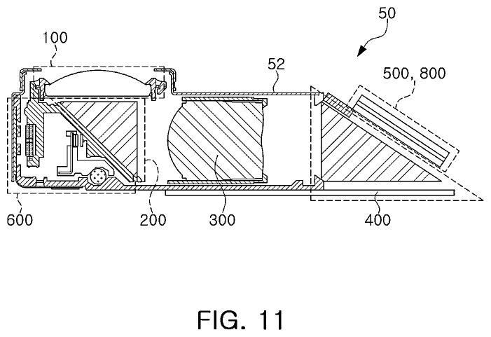

Next, a camera module according to a third embodiment will be described with reference to FIGS. 11 to 13.

A camera module 50 according to a third embodiment may include a first lens group 100, a first optical path conversion unit 200, a second lens group 300, a second optical path conversion unit 400, and an image sensor package 500. However, the configuration of the camera module 50 according to the third embodiment is not limited to the members or elements described above. As an example, the camera module 50 may further include a first driving unit 800 that drives the second optical path conversion unit 400.

The first lens group 100, the first optical path conversion unit 200, the second lens group 300, the second optical path conversion unit 400, and the image sensor package 500 may be sequentially arranged along the optical axis. For example, the first optical path conversion unit 200 may be disposed on the image side of the first lens group 100, the second lens group 300 may be disposed on the image side of the first optical path conversion unit 200, the second optical path conversion unit 400 may be disposed on the image side of the second lens group 300, and the image sensor package 500 may be disposed on the image side of the second optical path conversion unit 400.

The first lens group 100 may include one or more lenses sequentially arranged along the first optical axis C1. In an example, the first lens group 100 may include a first lens having refractive power. However, the number of lenses constituting the first lens group 100 is not limited to one lens. The first lens group 100 or the first lens may have a predetermined refractive power. For example, the first lens group 100 or the first lens may have positive refractive power. The first lens group 100 or the first lens may have an overall meniscus shape. For example, the object-side surface of the first lens disposed on the forefront in the first lens group 100 may be convex, and the image-side surface of the lens disposed rearmost in the first lens group 100 may be concave. The first lens group 100 may include lenses of a predetermined size. For example, the maximum diameter of the first lens disposed at the forefront of the first lens group 100 may be larger than the maximum length (horizontal or vertical length of the incident surface) of the first optical path conversion unit 200.

The first optical path conversion unit 200 may be configured to reflect light incident along the first optical axis C1 of the first lens group 100 in the direction of the second optical axis C2 of the second lens group 300. For example, the first optical path conversion unit 200 may be configured in the form of a prism that totally reflects light incident along the first optical axis C1 in the direction of the second optical axis C2. However, the form of the first optical path conversion unit 200 is not limited to a prism. For example, it may be possible to change the first optical path conversion unit 200 into a reflector.

The first optical path conversion unit 200 may be configured in the same or similar form as the first optical path conversion unit according to the first embodiment. For example, the first optical path conversion unit 200 may be changed to the shape illustrated in FIGS. 2A to 2C, other than the shape illustrated in FIG. 7.

The second lens group 300 may include one or more lenses sequentially arranged along the second optical axis C2. As an example, the second lens group 300 may include a second lens and a third lens sequentially arranged along the second optical axis C1. The second lens and the third lens may respectively have positive or negative refractive power. As a detailed example, the second lens may have positive refractive power and the third lens may have negative refractive power. However, the number of lenses, and the refractive powers of the lenses constituting the second lens group 300 are not limited to the above-described form. In an example, the second lens group 300 may be comprised of three or more lenses.

The second optical path conversion unit 400 may be configured to reflect light incident along the second optical axis C2 to the image sensor of the image sensor package 500. For example, the second optical path conversion unit 400 may include two or more reflective surfaces so that light incident along the second optical axis C2 may be incident along the third optical axis C3 of the image sensor. For example, the second optical path conversion unit 400 according to the second embodiment may have substantially the same or a similar form and characteristics as the second optical path conversion unit according to the first embodiment illustrated in FIG. 3.

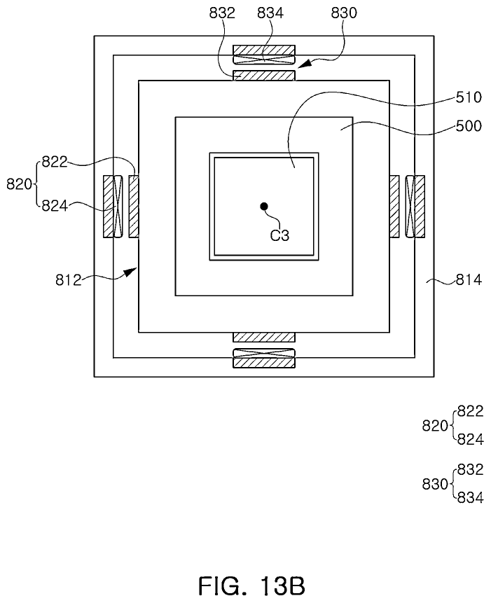

The image sensor package 500 may be configured to include an image sensor (see FIG. 13A). The image sensor package 500 may be disposed to face one surface of the second optical path conversion unit 400. As an example, the image sensor package 500 may be disposed to face the first reflective surface of the second optical path conversion unit 400.

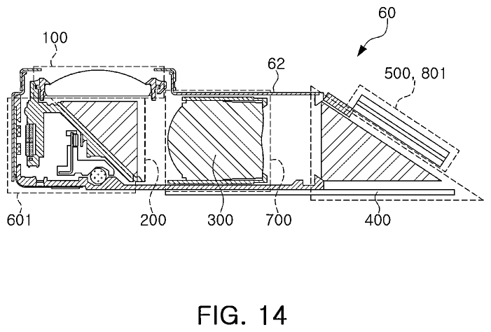

The camera module 50 according to the third embodiment may include a plurality of first driving units 601 and 801 (FIG. 14). For example, the camera module 50 may include a first driving unit 601 that drives the first optical path conversion unit 200 and a first driving unit 801 that drives the image sensor package 500. The first driving units 601 and 801 may be configured to enable optical image stabilization (OIS) of the camera module 50. In an example, the camera module 50 according to the present embodiment may perform optical image stabilization based on the first driving unit 601. As another example, the camera module 50 according to the present embodiment may perform optical image stabilization through the first driving unit 801. As another example, the camera module 50 according to the present embodiment may perform optical image stabilization by simultaneously or sequentially driving the first driving unit 601 and the first driving unit 801.

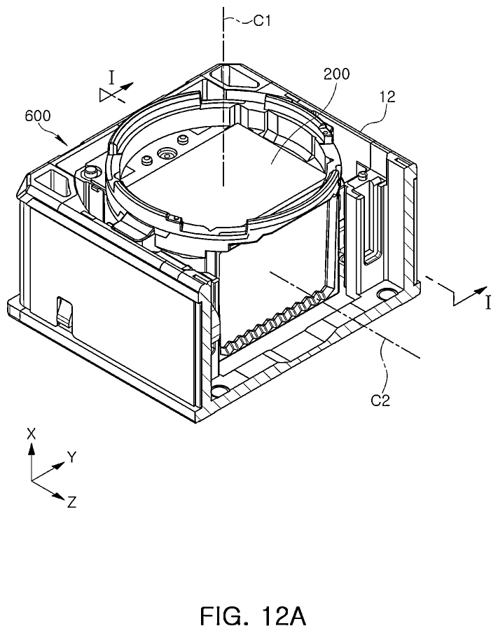

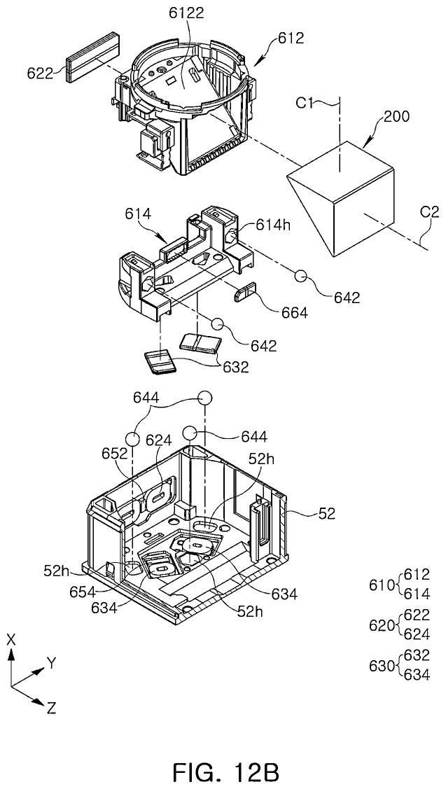

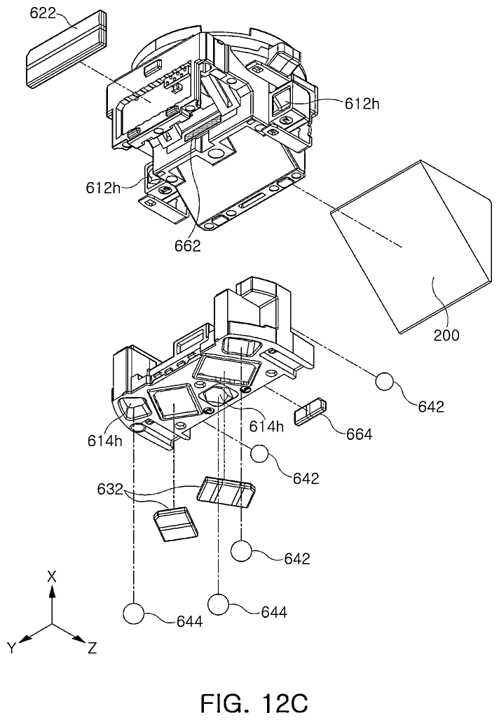

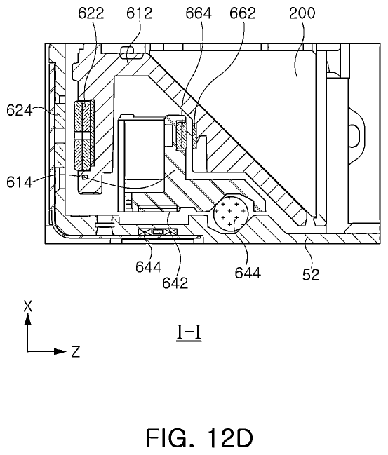

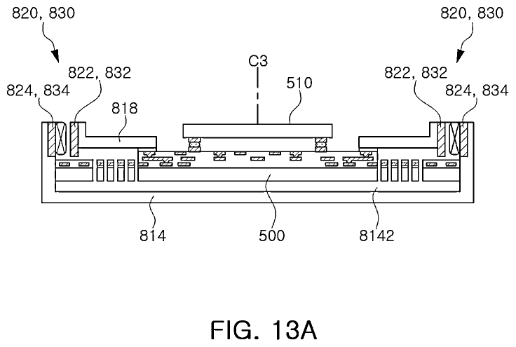

The first driving unit 601 will be described with reference to FIGS. 12A-12D.

The first driving unit 601 may be configured to partially contact or couple with the first optical path conversion unit 200, as illustrated in FIG. 12A. For example, the first driving unit 601 may be configured to support at least one of the reflective surface and the side surface of the first optical path conversion unit 200.

The first driving unit 601 may include a movable body 610, a first driving unit 620, and a second driving unit 630, as illustrated in FIGS. 12B and 12C. However, the configuration of the first driving unit 601 is not limited to the members or elements described above. For example, the first driving unit 601 may further include ball bearings 642 and 644 to enable smooth movement of the first optical path conversion unit 200 or the movable body 610. As another example, the first driving unit 601 may further include Hall sensors 652 and 654 to detect the position of the movable body 610.

The movable body 610 may be comprised of a plurality of members. As an example, the movable body 610 may be comprised of a first movable body 612 and a second movable body 614. However, the configuration of the movable body 610 is not limited to the first movable body 612 and the second movable body 614. For example, the movable body 610 may be comprised of three or four members as needed. The first movable body 612 may be configured to support the first optical path conversion unit 200. As an example, a receiving portion 6122 on which the first optical path conversion unit 200 may be seated may be formed in the first movable body 612. The second movable body 614 may be configured to support the first movable body 612. The second movable body 614 may be disposed in the housing 52 of the camera module 50. In an example, the second movable body 614 may be disposed on the inner bottom of the housing 52. The first movable body 612 and the second movable body 614 may be configured to rotate or move, respectively. As an example, the first movable body 612 is configured to rotate or move in one direction while being coupled to the second movable body 614, and the second movable body 614 may be configured to rotate or move in a different direction while being in the housing 52.

The first driving unit 620 may be configured to drive the first movable body 612. For example, the first driving unit 620 may rotate the first movable body 612 in a direction intersecting the first optical axis C1 and the second optical axis C2. The first driving unit 620 may include a first driving magnet 622 and a first driving coil 624. However, the configuration of the first driving unit 620 is not limited to the members or elements described above. The first driving magnet 622 may be formed in the first movable body 612. For example, the first driving magnet 622 may be formed on the rear surface of the first movable body 612 facing one surface of the housing 52. The first driving coil 624 may be formed in the housing 52. In an example, the first driving coil 624 may be formed on the inner side surface of the housing 12 facing the first driving magnet 622. The first driving magnet 622 and the first driving coil 624 disposed in this manner may rotate or drive the first movable body 612 in one direction through the magnetic force generated therebetween.

The second driving unit 630 may be configured to drive the second movable body 614. For example, the second driving unit 630 may rotate the second movable body 614 about the first optical axis C1. The second driving unit 630 may include a second driving magnet 632 and a second driving coil 634. However, the configuration of the second driving unit 630 is not limited to the members described above. The second driving magnet 632 may be formed in the second movable body 614. In an example, the second driving magnet 632 may be formed on the lower surface of the second movable body 614 facing the bottom of the housing 52. The second driving coil 634 may be formed in the housing 52. In an example, the second driving coil 634 may be formed on the bottom of the housing 12 facing the second driving magnet 632. The second driving magnet 632 and the second driving coil 634 disposed in this manner may rotate or drive the second movable body 614 in one direction through the magnetic force generated therebetween.

The ball bearings 642 and 644 may be configured to enable a smooth operation of the first movable body 612 and the second movable body 614. As an example, the first ball bearing 642 may be disposed between the first movable body 612 and the second movable body 614, and the second ball bearing 644 may be disposed between the second movable body 614 and the housing 52. In an example, grooves 612h, 614h, and 12h to receive ball bearings 642 and 644 may be formed in the first movable body 612, the second movable body 614, and the housing 12, respectively. On the other hand, at least some of the grooves 612h, 614h, and 12h may have a polygonal cross-sectional shape rather than a circular shape, to significantly reduce the contact area with the ball bearings 642 and 644.

Hall sensors 652 and 654 may be configured to detect the positions of the first movable body 612 and the second movable body 614. For example, the first Hall sensor 652 may be disposed between respective coils of the first driving coil 624 or adjacent to the first driving coil 624 and may be configured to detect the movement of the first movable body 612, and the second Hall sensor 654 may be disposed on one side of the second driving coil 634 and configured to sense the movement of the second movable body 614. However, the arrangement of the Hall sensors 652 and 654 is not limited to the above-mentioned positions.

The first driving unit 601 may further include a component that prevents the first movable body 612 from being separated. For example, the first driving unit 600 may include a pair of magnetic bodies 662 and 664 configured to generate an attractive force between the first movable body 612 and the second movable body 614. The first magnetic body 662 may be disposed on one side of the first movable body 612 (see FIGS. 12C and 12D), and the second magnetic body 664 may be disposed on one side of the second movable body 614 (see FIGS. 12B and 12D). The magnetic bodies 662 and 664 configured in this manner may suppress the separation of the first movable body 612 from the second movable body 614 through mutual attraction.

The first driving unit 801 will be described with reference to FIGS. 13A and 13B.

The first driving unit 801 may be formed in the image sensor package 500. In an example, the first driving unit 801 may be formed in a partial area of the image sensor package 500 or may be formed integrally with the image sensor package 500. In another example, the first driving unit 801 may be configured to accommodate the image sensor package 500. The first driving unit 801 may include a movable body 812, a fixed body 814, a first driving unit 820, and a second driving unit 830. However, the configuration of the first driving unit 801 is not limited to the above-described members.

The movable body 812 may be configured to be combined with the image sensor package 500 or the image sensor 510. For example, the movable body 812 may be coupled to the image sensor package 500 or may be configured to accommodate the image sensor 510. The movable body 812 may be configured to be electrically connected to the image sensor package 500 or the image sensor 510. For example, the movable body 812 may be configured in the form of a printed circuit board. However, the shape of the movable body 812 is not limited to a printed circuit board. The fixed body 814 may be configured to accommodate the movable body 812. For example, a receiving portion 8142 may be formed inside the fixed body 814 to accommodate the movable body 812 and the image sensor package 500. Similar to the movable body 812, the fixed body 814 may be configured to be electrically connected to the image sensor package 500 or the image sensor 510. For example, the fixed body 814 may be configured in the form of a printed circuit board. However, the shape of the fixed body 814 is not limited to a printed circuit board.

The first driving unit 820 may include a first driving magnet 822 and a first driving coil 824. However, the configuration of the first driving unit 820 is not limited to the members or elements described above. The first driving magnet 822 and the first driving coil 824 may be disposed to face each other or be adjacent to each other. In an example, the first driving magnet 822 may be formed in the movable body 812, and the first driving coil 824 may be formed in the fixed body 814. In another example, the first driving magnet 822 may be formed on the fixed body 814, and the first driving coil 824 may be formed on the movable body 812. The first driving unit 820 configured in this manner may move the image sensor 510 or the image sensor package 500 in the first direction that intersects the third optical axis C3, based on the magnetic force generated between the first driving magnet 822 and the first driving coil 824.

The second driving unit 830 may include a second driving magnet 832 and a second driving coil 834. However, the configuration of the second driving unit 830 is not limited to the members or elements described above. The second driving magnet 832 and the second driving coil 834 may be disposed to face each other, or may be disposed adjacent to each other. In an example, the second driving magnet 832 may be formed in the movable body 812, and the second driving coil 834 may be formed in the fixed body 814. In another example, the second driving magnet 832 may be formed on the fixed body 814, and the second driving coil 834 may be formed on the movable body 812. The second driving unit 830 configured in this manner may move the image sensor 510 or the image sensor package 500 in the second direction intersecting the third optical axis C3, based on the magnetic force generated between the second driving magnet 832 and the second driving coil 834.

In an example, the driving units 820 and 830 according to the present embodiment may be comprised of a driving magnet and a driving coil. However, this is only an example, and it may also be possible to change the configuration of the driving units 820 and 830 in the range of moving the movable body 812 in a direction intersecting the third optical axis C3. For example, in a modified form of the embodiment, it may be possible to change the driving units 820 and 830 to a shape memory alloy, a piezoelectric member, or the like.

The camera module 50 configured as above may implement a telephoto imaging optical system with a long focal length. Additionally, in the camera module 50 according to the present embodiment, the plurality of first driving units 601 and 801 may simultaneously or selectively drive at least one or more of the first optical path conversion unit 200 and the image sensor package 500, thereby performing quick and detailed optical image stabilization. Additionally, in the camera module 50 according to the present embodiment, the image sensor package 500 may be widely disposed in the diagonal direction of the first optical path conversion unit 300, and thus, it may be easy to mount large image sensors and electronic components necessary for high-resolution implementation.

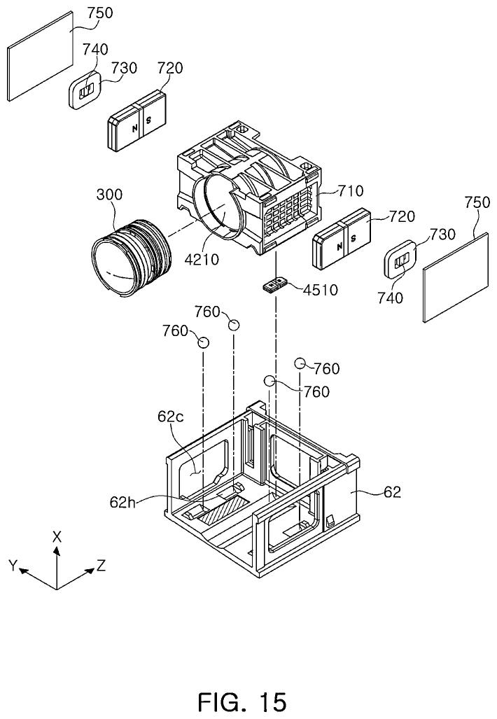

Next, another form of the camera module according to the third embodiment will be described with reference to FIGS. 14 and 15.

In an example, in the camera module 60 according to this form, components that are the same as those in the above-described embodiment use substantially the same symbols as those in the above-described embodiment, and detailed descriptions of these components are omitted.

A camera module 60 according to this form may be distinguished from the camera module 50 according to the above-described embodiment in that it further includes a second driving unit 700. Specifically, the camera module 20 according to this form may further include a second driving unit 700 that drives the second lens group 300 in the direction of the second optical axis C2.

The configuration of the second driving unit 700 will be described with reference to FIG. 15.

The second driving unit 700 may include a movable body 710, a driving magnet 720, a driving coil 730, a detection sensor 740, and a circuit board 750. However, the configuration of the second driving unit 700 is not limited to the members described above. In an example, the second driving unit 700 may further include a ball bearing 760.

The movable body 710 may be disposed inside the housing 62. For example, the movable body 710 may be disposed while maintaining a predetermined distance from the bottom of the housing 62 or may be disposed to partially contact the bottom of the housing 62. The movable body 710 may be configured to accommodate the second lens group 300. In an example, a receiving portion 712 may be formed in the movable body 710 to accommodate the second lens group 300. The movable body 710 may be configured to move in the direction of the second optical axis C2. Specifically, the movable body 710 may be moved along the second optical axis C2 while being combined with the second lens group 300. In an example, a ball bearing 760 may be disposed between the movable body 710 and the housing 62 to allow the movable body 710 to move smoothly. Specifically, the ball bearing 760 may be disposed between the groove 42h of the housing 62 and the groove 714h of the movable body 710.

The driving magnet 720 and the driving coil 730 may be formed in the movable body 710 and the housing 62, respectively. For example, the driving magnet 720 may be formed on both sides of the movable body 710, and the driving coil 730 may be disposed in the through hole 62c of the housing 62, using the substrate 750 as a medium. The driving magnet 720 and the driving coil 730 may be disposed to face each other. The driving magnet 720 and driving coil 730 configured in this manner may move the second lens group 300 and the movable body 710. For example, the driving magnet 720 and the driving coil 730 may move the second lens group 300 and the movable body 710 in the direction of the second optical axis C2. For reference, the driving magnet 720 is preferably formed long in the direction of the second optical axis C2 so that it may interact with the driving coil 730 even in a changed position of the movable body 710.

The camera module 60 configured as above includes all the features of the camera module 50 described above and has the feature of being able to adjust the focal length of the camera module through the second driving unit 700.

As set forth above, a camera module according to an embodiment may be mounted on a small portable terminal.

In addition, a camera module according to an embodiment may enable high-resolution imaging and shooting while having a long focal length.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a first lens group comprising a lens disposed in a direction of a first optical axis;
a second lens group comprising a lens disposed in a direction of a second optical axis, intersecting the first optical axis;
a first optical path conversion unit configured to reflect light incident through the first lens group to the second lens group;
an image sensor configured to convert light incident through the second lens group into an electrical signal, and having a third optical axis which intersects the second optical axis;
a second optical path conversion unit disposed between the second lens group and the image sensor and configured to reflect the light incident through the second lens group to the image sensor; and
a first driving unit configured to drive at least one of the first optical path conversion unit and the image sensor,
wherein the first optical axis and the third optical axis are configured to form an acute angle.

2. The camera module of claim 1, wherein the first driving unit is configured to move the first optical path conversion unit in a first direction intersecting the first optical axis.

3. The camera module of claim 1, wherein the first driving unit is configured to move the first optical path conversion unit in a first direction intersecting the first optical axis and a second direction intersecting the first optical axis.

4. The camera module of claim 1, wherein the first driving unit is configured to move the image sensor in a third direction intersecting the third optical axis.

5. The camera module of claim 1, wherein the first driving unit is configured to move the image sensor in a third direction intersecting the third optical axis and a fourth direction intersecting the third optical axis.

6. The camera module of claim 1, further comprising a second driving unit configured to move the second lens group in the direction of the second optical axis.

7. The camera module of claim 1, wherein the first optical path conversion unit is configured to have positive refractive power.

8. The camera module of claim 7, wherein an emission surface of the first optical path conversion unit has a convex shape.

9. A camera module, comprising:
a first lens group, a first optical path conversion unit, a second lens group, a second optical path conversion unit, and an image sensor arranged sequentially along an optical axis direction, and
a first driving unit configured to drive the first optical path conversion unit in a direction intersecting an optical axis,
wherein the image sensor is disposed to form an acute angle with an entrance surface of the second optical path conversion unit.

10. The camera module of claim 9, further comprising a second driving unit configured to drive the second lens group in the optical axis direction.

11. The camera module of claim 10, further comprising a ball bearing disposed between the second lens group and a housing that accommodates the second lens group.

12. The camera module of claim 9, wherein the first lens group has positive refractive power.

13. The camera module of claim 9, wherein an emission surface of the first optical path conversion unit has a convex shape.

14. The camera module of claim 9, wherein the first driving unit is configured to drive the first optical path conversion unit in a first direction intersecting the optical axis and a second direction intersecting the optical axis.

15. The camera module of claim 9, wherein the second optical path conversion unit is configured to include two or more reflective surfaces.

16. A camera module, comprising:
a first lens group comprising at least one lens disposed in a direction of a first optical axis;
a second lens group disposed in a direction of a second optical axis, intersecting the first optical axis;
an image sensor;
a first optical path conversion unit configured to reflect light incident through the first lens group to the second lens group;
a second optical path conversion unit disposed between the second lens group and the image sensor and configured to reflect light incident through the second lens group to the image sensor; and
a driving unit configured to move the first optical path conversion unit in a direction intersecting the first optical axis, and configured to rotate the first optical path conversion unit based on the first optical axis.

17. The camera module of claim 16, wherein a second lens of the second lens group has positive refractive power, and a third lens of the second lens group has negative refractive power.
